(19) United States
(12) Patent Application Publication
(10) Pub. No.: US 2024/0079674 A1
(43) Pub. Date: Mar. 7, 2024

(54) POWER STORAGE DEVICE

(71) Applicant: SUBARU CORPORATION, Tokyo (JP)

(72) Inventor: Yutaka YOKOYAMA, Tokyo (JP)

(21) Appl. No.: 18/233,707

(22) Filed: Aug. 14, 2023

(30) Foreign Application Priority Data
Sep. 2, 2022 (JP) 2022-139863

(51) Int. Cl. H01M 10/6556; B60K 1/04; B60K 11/02; B60L 50/60; H01M 10/613; H01M 10/625; H01M 10/6554; H01M 50/209; H01M 50/249; H01M 50/291

(52) U.S. Cl. CPC H01M 10/6556; B60K 1/04; B60K 11/02; B60L 50/66; H01M 10/613; H01M 10/625; H01M 10/6554; H01M 50/209; H01M 50/249; H01M 50/291; B60K 2001/005; B60K 2001/0438; H01M 2220/20

(57) ABSTRACT

A power storage device to be mounted below a floor of a vehicle includes a battery tray, a battery frame, and a cooling plate. The battery tray accommodates a secondary battery cell. The battery frame surrounds the battery tray. The cooling plate includes a plate portion provided above the battery tray and the battery frame and having a refrigerant flow path through which a refrigerant flows, and a main pipe disposed on an outer side of the battery frame so as to overlap the battery frame in a top-bottom direction and continuous with the plate portion such that the refrigerant flow path and an internal space of the main pipe communicate with each other.

### CROSS-REFERENCE TO RELATED APPLICATIONS

The present application claims priority from Japanese Patent Application No. 2022-139863 filed on Sep. 2, 2022, the entire contents of which are hereby incorporated by reference.

### BACKGROUND

The disclosure relates to a power storage device to be mounted on a vehicle.

Japanese Unexamined Patent Application Publication No. 2013-229182 discloses a power storage device to be mounted on a vehicle, the power storage device including a battery block in which multiple secondary battery cells are coupled in series, a cooling plate that is provided below the battery block and cools the battery block, and a cover that covers the battery block from above.

### SUMMARY

An aspect of the disclosure provides a power storage device to be mounted below a floor of a vehicle. The power storage device includes a battery tray, a battery frame, and a cooling plate. The battery tray accommodates a secondary battery cell. The battery frame surrounds the battery tray. The cooling plate includes a plate portion provided above the battery tray and the battery frame and having a refrigerant flow path through which a refrigerant flows, and a main pipe disposed on an outer side of the battery frame so as to overlap the battery frame in a top-bottom direction and continuous with the plate portion such that the refrigerant flow path and an internal space of the main pipe communicate with each other.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 illustrates a configuration of a vehicle;

FIG. 2 is an exploded perspective view illustrating a configuration of a power storage device;

FIG. 3 illustrates secondary battery cells accommodated in a battery tray;

FIG. 4 is a sectional view of the power storage device taken along line IV-IV in FIG. 2;

FIG. 5 is a sectional view of the power storage device taken along line V-V in FIG. 2;

FIG. 6 is a sectional view of the power storage device according to a second embodiment;

FIG. 7 is a sectional view of the power storage device according to the second embodiment; and

FIG. 8 is an exploded perspective view illustrating a configuration of a power storage device according to a modification.

### DETAILED DESCRIPTION

In a power storage device of the related art, when an external force is applied due to a collision of a vehicle or the like, a cooling plate may be damaged, and a secondary battery cell may leak due to refrigerant flowing through the cooling plate.

It is desirable to reduce leakage of a secondary battery cell.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. First Embodiment

### 1.1. Configuration of Vehicle 1

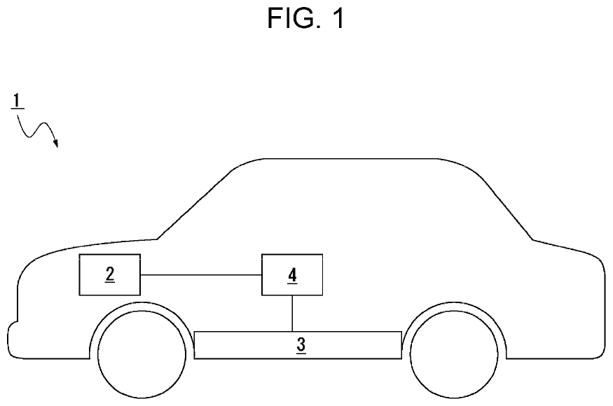

FIG. 1 illustrates a configuration of a vehicle 1. As illustrated in FIG. 1, the vehicle 1 is an electric automobile including a motor 2, a power storage device 3, and an inverter 4. The vehicle 1 may be a hybrid automobile.

The motor 2 is a power source for causing the vehicle 1 to travel and is, for example, a three-phase AC motor. When electric power is supplied from the power storage device 3 via the inverter 4, the motor 2 generates driving force and transmits the driving force to driving wheels, thereby causing the vehicle 1 to travel. When the vehicle 1 is a hybrid automobile, the vehicle 1 also includes an engine as the power source.

The motor 2 generates electricity (electric power) by performing a regenerative operation. The electricity generated by the regenerative operation of the motor 2 is supplied to the power storage device 3 via the inverter 4.

The power storage device 3 is a so-called high-voltage battery and is capable of storing electricity to be supplied to the motor 2. The power storage device 3 is mounted, for example, below the floor of the vehicle 1.

The inverter 4 converts a direct current supplied from the power storage device 3 into a three-phase alternating current and supplies the alternating current to the motor 2. When the motor 2 performs regenerative operation, the inverter 4 converts an alternating current supplied from the motor 2 into a direct current and supplies the direct current to the power storage device 3.

The power storage device 3 can be charged by the regenerative operation of the motor 2. The power storage device 3 can also be charged by supplying electricity from an external device (not illustrated).

### 1.2. Configuration of Power Storage Device According to First Embodiment

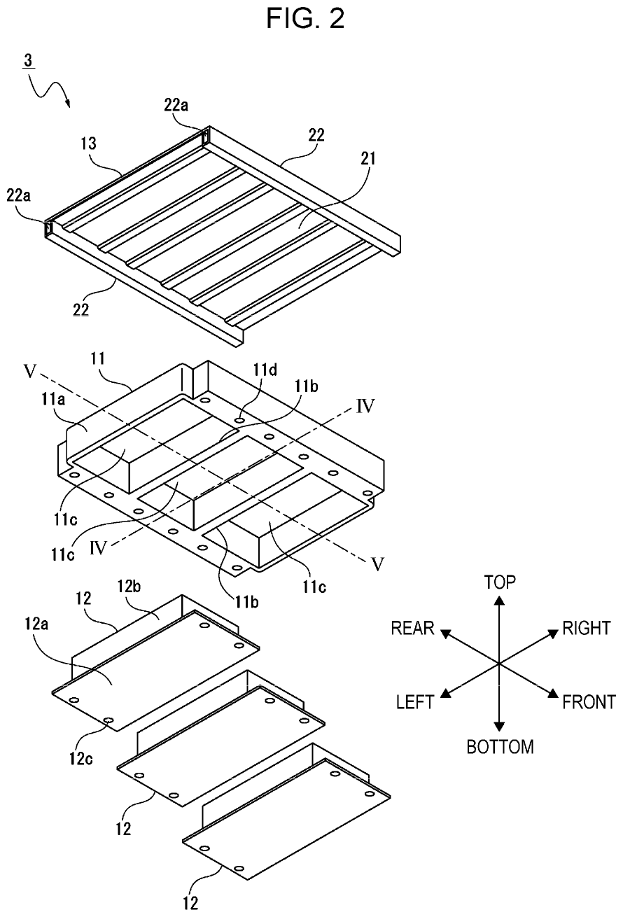

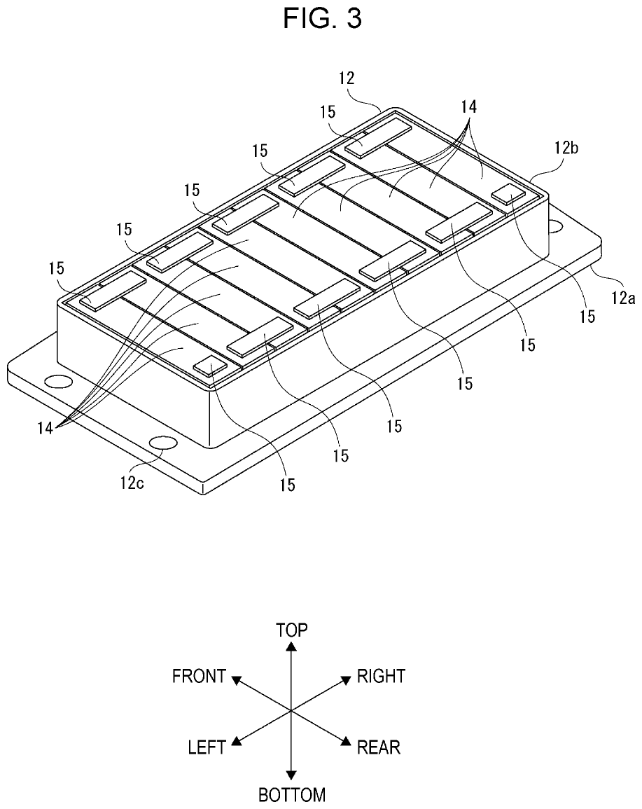

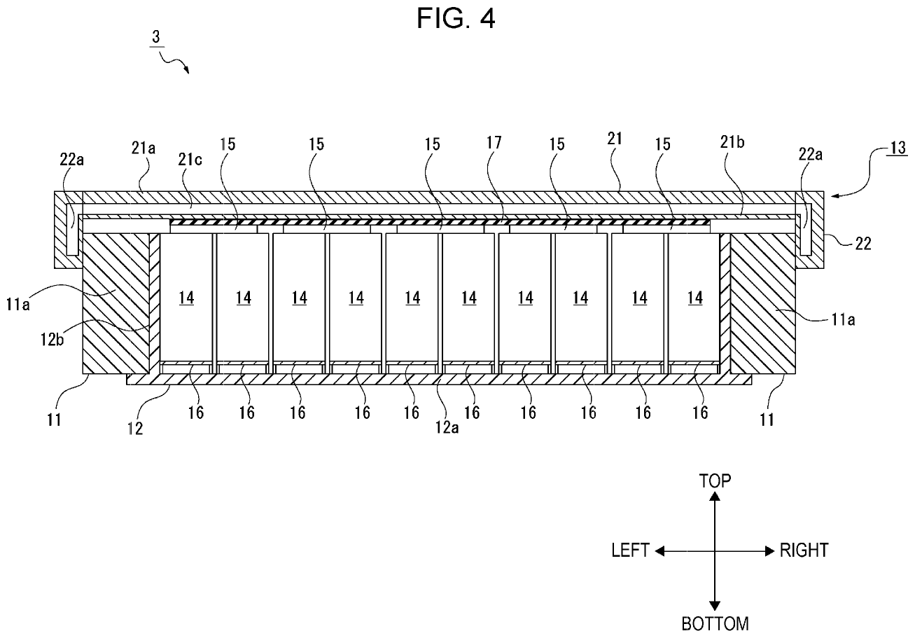

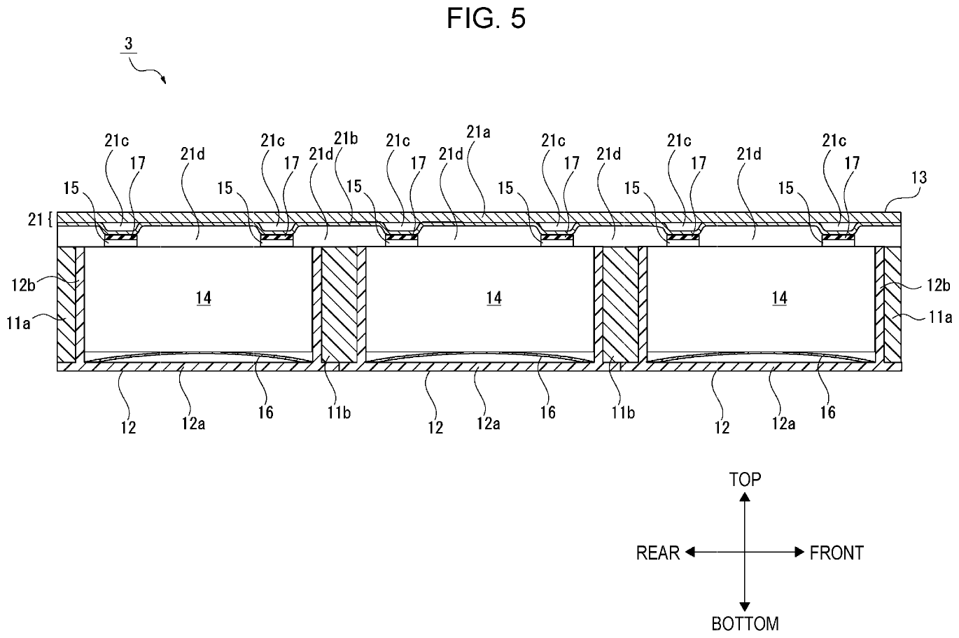

FIG. 2 is an exploded perspective view illustrating the configuration of the power storage device 3. FIG. 3 illustrates secondary battery cells 14 accommodated in a battery tray 12. FIG. 4 is a sectional view of the power storage device 3 taken along line IV-IV in FIG. 2. FIG. 5 is a sectional view of the power storage device 3 taken along line V-V in FIG. 2.

As illustrated in FIGS. 2 to 5, the power storage device 3 includes a battery frame 11, battery trays 12, a cooling plate 13, and multiple secondary battery cells 14. The battery frame 11, the battery trays 12, and the cooling plate 13 are fixed to the vehicle body.

The battery frame 11 is formed of, for example, aluminum, iron, or a resin material.

A main body 11a of the battery frame 11 has a substantially quadrangular frame shape that is long in the front-rear direction and short in the left-right direction.

The battery frame 11 has, in the space surrounded by the main body 11a, multiple (two in the drawing) ribs 11b provided at predetermined intervals in the front-rear direction. Ends of the ribs 11b in the left-right direction are bonded to the main body 11a by welding or the like in the space surrounded by the main body 11a.

With this configuration, multiple (three in the drawing) spaces for accommodating the battery trays 12 are formed inside the battery frame 11. Hereinbelow, the spaces surrounded by the main body 11a and divided by the ribs 11b will be referred to as accommodating spaces 11c.

The main body 11a has, in the left and right portions extending in the front-rear direction, multiple screw grooves 11d provided at predetermined intervals in the front-rear direction.

The battery trays 12 are formed of, for example, resin. The battery trays 12 each include a bottom member 12a and a frame member 12a projecting upward from the bottom member 12b in a substantially quadrangular frame shape, which are formed as a single component. The space surrounded by the bottom member 12a and the frame member 12b accommodates the secondary battery cells 14.

The bottom member 12a is a plate-like member slightly larger than the accommodating space 11c. The bottom member 12a has, in the right and left ends thereof, through-holes 12c provided at positions facing the screw grooves 11d.

The frame member 12b is slightly smaller than the accommodating space 11c so as to fit in the accommodating space 11c.

The battery trays 12 are inserted from below into the accommodating spaces 11c in the battery frame 11 fixed to the vehicle body, and are fixed to the battery frame 11 with bolts or the like screwed through the through-holes 12c into the screw grooves 11d. That is, the battery trays 12 can be attached to the battery frame 11 from below.

As illustrated in FIG. 3, each battery tray 12 accommodates multiple secondary battery cells 14. The secondary battery cells 14 are, for example, lithium-ion batteries or the like and can be repeatedly charged and discharged.

The secondary battery cells 14 are slightly shorter than the frame member 12b in the front-rear direction, are sufficiently shorter than the frame member 12b in the left-right direction, and are slightly shorter than the frame member 12b in the top-bottom direction. Multiple (ten in the drawing) secondary battery cells 14 arranged side-by-side in the left-right direction are accommodated in the frame member 12b.

The secondary battery cells 14 are coupled in series by bus bars 15. The bus bars 15 are formed of a highly conductive metal. The bus bars 15 are disposed on the upper surfaces of the secondary battery cells 14, at the ends thereof in the front-rear direction, so as to connect the adjoining secondary battery cells 14 in the left-right direction. The bus bars 15 disposed on the front side and the bus bars 15 disposed on the rear side are arranged in lines extending in the left-right direction.

Spring members 16 are provided between the secondary battery cells 14 and the bottom member 12a of the battery tray 12. The spring members 16 are, for example, disc springs or plate springs and are elastically deformable. When the battery trays 12 are fixed inside the battery frame 11, the spring members 16 press the secondary battery cells 14 upward, that is, toward the cooling plate 13.

The cooling plate 13 includes a plate portion 21 and main pipes 22 continuous with the ends of the plate portion 21 in the left-right direction and cools the secondary battery cells 14.

The plate portion 21 has a double-plate structure in which two plates 21a and 21b made of, for example, aluminum overlap each other in the top-bottom direction. The upper plate 21a of the plate portion 21 is flat. The lower plate 21b of the plate portion 21 has a predetermined concavo-convex pattern. In the plate portion 21, the two plates 21a and 21b overlap each other in the top-bottom direction, forming refrigerant flow paths 21c (spaces) through which refrigerant flows therebetween.

For example, the refrigerant flow paths 21c are formed along the bus bars 15 coupling the secondary battery cells 14. As described above, because the bus bars 15 are arranged in lines extending in the left-right direction, multiple (six in the drawing) refrigerant flow paths 21c extending in the left-right direction and facing the bus bars 15 are formed at intervals in the front-rear direction.

The main pipes 22 are formed of members having lower rigidity than the battery frame 11. The main pipes 22 have substantially the same length as the plate portion 21 in the front-rear direction and have internal spaces 22a through which the refrigerant flows and which extend in the front-rear direction.

The main pipes 22 are continuous with the plate portion 21 such that the refrigerant flow paths 21c formed in the plate portion 21 and the internal spaces 22a communicate with each other.

A radiator (not illustrated) is coupled to the main pipes 22 via refrigerant pipes, and the refrigerant cooled by the radiator is supplied to one main pipe 22. The refrigerant supplied to the one main pipe 22 is distributed among the refrigerant flow paths 21c of the plate portion 21. The distributed refrigerant is collected in the other main pipe 22 after passing through the respective refrigerant flow paths 21c. Then, the refrigerant is discharged from the other main pipe 22 to the radiator, is cooled by the radiator, and is then supplied to the one main pipe 22.

This way, the refrigerant circulates through one main pipe 22, the plate portion 21, the other main pipe 22, the radiator, and the one main pipe 22.

The cooling plate 13 is fixed to the battery frame 11 so as to cover the battery frame 11 from above. At this time, the cooling plate 13 is fixed to the battery frame 11 such that portions of the plate 21b forming the refrigerant flow paths 21c are in contact with the bus bars 15 with insulating members 17 therebetween. The insulating members 17 are an insulator having a high thermal conductivity. With this configuration, in the power storage device 3, it is possible to efficiently cool the bus bars 15, which generate a large amount of heat, and thus to improve the cooling efficiency.

When the cooling plate 13 is fixed to the battery frame 11, the main pipes 22 are positioned on the outer side of the battery frame 11 in the left-right direction. The main pipes 22 extend below the upper surface of the battery frame 11. In other words, the main pipes 22 overlap the battery frame 11 in the top-bottom direction.

It is assumed that an external force acts on the power storage device 3 when the vehicle 1 collides from a side (left-right direction), for example. At this time, because the main pipes 22 overlap the battery frame 11 in the top-bottom direction, the external force acting on the power storage device 3 is applied to the main pipes 22, which are disposed on the outermost side in the left-right direction.

When the main pipes 22 are broken by the external force applied to the main pipes 22, the refrigerant leaks from the main pipes 22. At this time, because the main pipes 22 are disposed on the outer side of the battery frame 11, the refrigerant is prevented from entering the battery trays 12 disposed inside the battery frame 11. Hence, the risk of the secondary battery cells 14 coming into contact with the refrigerant and leaking is reduced.

Furthermore, the plate portion 21 has, between the refrigerant flow paths 21c in the front-rear direction, exhaust flow paths 21d separated from the secondary battery cells 14 in the top-bottom direction. The exhaust flow paths 21d are formed such that portions of the plate 21b of the plate portion 21 are recessed upward. With this configuration, even if smoke is generated from the secondary battery cells 14, the smoke is discharged to the outside through the exhaust flow paths 21d.

### 2. Second Embodiment

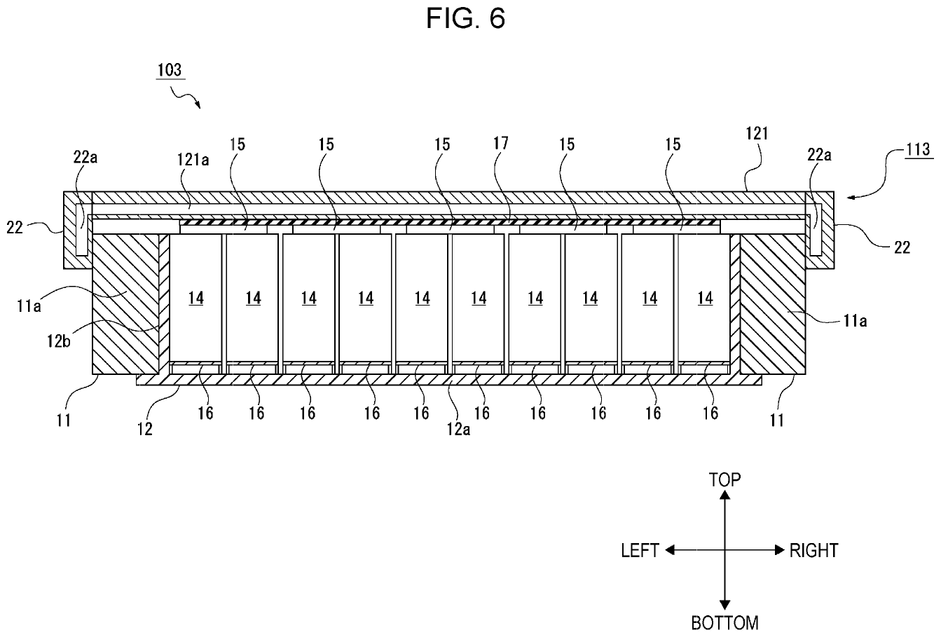

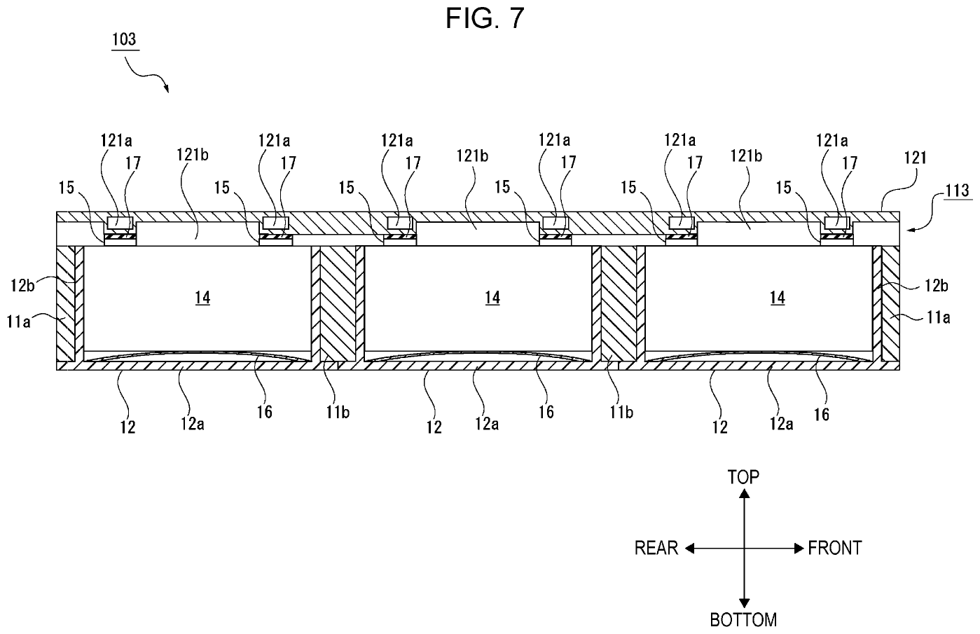

FIGS. 6 and 7 are sectional views of a power storage device 103 according to a second embodiment. FIG. 6 is a sectional view similar to FIG. 4 in the first embodiment. FIG. 7 is a sectional view similar to FIG. 5 in the first embodiment.

The power storage device 103 according to the second embodiment is the same as the power storage device 3 according to the first embodiment, except for a cooling plate 113 Hence, the structure of the cooling plate 113 will be mainly described here, and the same structures as those of the first embodiment will be denoted by the same reference signs, and the description thereof will be omitted.

As illustrated in FIGS. 6 and 7, the power storage device 103 includes the battery frame 11, the battery trays 12, the cooling plate 113, and the secondary battery cells 14.

The cooling plate 113 includes a plate portion 121 and the main pipes 22 continuous with the ends of the plate portion 121 in the left-right direction.

The plate portion 121 is formed by extrusion molding in which, for example, aluminum is extruded in the left-right direction such that multiple refrigerant flow paths 121a and exhaust flow paths 121b extending in the left-right direction are formed.

The refrigerant flow paths 121a are formed along the bus bars 15 coupling the secondary battery cells 14. As described above, because the bus bars 15 are arranged in lines extending in the left-right direction, multiple (six in the drawing) refrigerant flow paths 121a extending in the left-right direction and facing the bus bars 15 are formed at intervals in the front-rear direction.

The refrigerant flow paths 121a communicate with the internal spaces 22a of the main pipes 22. Hence, the refrigerant circulates through one main pipe 22, the refrigerant flow paths 121a of the plate portion 121, the other main pipe 22, the radiator, and the one main pipe 22.

The cooling plate 113 is fixed to the battery frame 11 so as to cover the battery frame 11 from above. At this time, the cooling plate 113 is fixed to the battery frame 11 such that portions of the plate portion 121 forming the refrigerant flow paths 121a are in contact with the bus bars 15 with insulating members 17 therebetween. With this configuration, in the power storage device 103, it is possible to efficiently cool the bus bars 15, which generate a large amount of heat, and thus to improve the cooling efficiency.

It is assumed that an external force acts on the power storage device 3 when the vehicle 1 collides from a side, for example. At this time, as in the first embodiment, because the main pipes 22 overlap the battery frame 11 in the top-bottom direction, the external force acting on the power storage device 103 is applied to the main pipes 22, which are disposed on the outermost side in the left-right direction.

When the main pipes 22 are broken by the external force applied to the main pipes 22, the refrigerant leaks from the main pipes 22. At this time, because the main pipes 22 are disposed on the outer side of the battery frame 11, the refrigerant is prevented from entering the battery trays 12 disposed inside the battery frame 11. Hence, the risk of the secondary battery cells 14 coming into contact with the refrigerant and leaking is reduced.

In addition, because the plate portion 121 is formed by extrusion molding in which the material is extruded in the left-right direction, the plate portion 121 has high rigidity against an external force applied in the left-right direction. Hence, it is possible to reduce crushing of the secondary battery cells 14.

The exhaust flow paths 121b are formed between the refrigerant flow paths 121a in the front-rear direction such that portions of the plate portion 121 are recessed upward. With this configuration, even if smoke is generated from the secondary battery cells 14, the smoke is discharged to the outside through the exhaust flow paths 121b.

### 3. Modifications

The above-described embodiments are examples for carrying out the disclosure, and the embodiments of the disclosure are not limited to the above-described examples, and various modifications are possible.

For example, in the above-described embodiments, the plate portion 21, 121 is in contact with the bus bars 15 with the insulating members 17 therebetween. However, the plate portion 21, 121 may be in contact with the bus bars 15 and the upper surfaces of the secondary battery cells 14. Alternatively, the plate portion 21, 121 may be in contact with the upper surfaces of the secondary battery cells 14.

Although multiple battery trays 12 are provided in the above-described embodiments, the number of the battery trays 12 may be one. However, by providing multiple battery trays 12, it is unnecessary to manufacture battery trays 12 of various sizes for different vehicle types, and the battery capacity can be changed by changing the number of battery trays 12 to be mounted. In addition, because the failed battery tray 12 alone is replaced in the case of failure of the power storage device 3, 103, the work efficiency is improved. Furthermore, when the battery trays 12 (the secondary battery cells 14) are repurposed and used, the battery trays 12 can be divided and recombined.

Although the spring members 16 are provided between the secondary battery cells 14 and the bottom member 12a of the battery tray 12 in the above-described embodiments, the spring members 16 may be omitted.

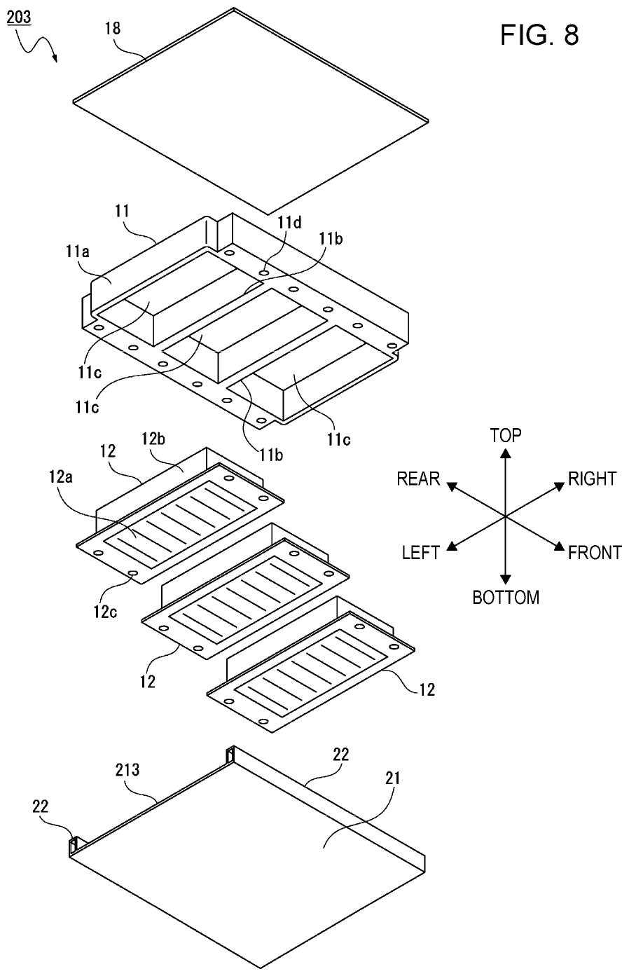

In the above-described embodiments, the cooling plate 13, 113 is provided above the battery frame 11 and the battery trays 12. However, as in a power storage device 203 according to a modification, as illustrated in FIG. 8, a cooling plate 213 may be provided below the battery frame 11 and the battery trays 12.

The power storage device 203 includes the battery frame 11, the battery trays 12, the cooling plate 213, and an upper cover 18. The cooling plate 213 is provided below the battery frame 11 and the battery trays 12 and cools the secondary battery cells 14 from below. Also in this case, the main pipes 22 are disposed on the outer side of the battery frame 11 so as to overlap the battery frame 11 in the top-bottom direction. In the power storage device 203, the upper cover 18 that closes the upper openings of the battery trays 12 is attached. As illustrated in FIG. 8, the battery trays 12 may be provided with through-holes in the bottom members 12a to improve the cooling effect.

Alternatively, in the power storage device 203, the battery trays 12 may be open to the lower side, and the openings may be closed by the cooling plate 213, without providing the upper cover 18. Furthermore, the bus bars 15 may be disposed on the lower surfaces of the secondary battery cells 14.

### 4. Conclusion

As described above, the power storage device 3, 103 according to the embodiments is configured to be mounted below the floor of the vehicle 1 and includes: the battery trays 12 configured to accommodate the secondary battery cells 14; the battery frame 11 surrounding the battery trays 12; and the cooling plate 13, 113 having the plate portion 21, 121 provided above the battery trays 12 and the battery frame 11 and forming the refrigerant flow paths 21c, 121a through which the refrigerant flows, and the main pipes 22 that are disposed on the outer side of the battery frame 11 so as to overlap the battery frame 11 in the top-bottom direction and are continuous with the plate portion 21, 121 so that the refrigerant flow paths 21c, 121a communicate with the internal spaces 22a.

With this configuration, in the power storage device 3, 103, when the vehicle 1 collides from a side, the external force is applied to the main pipes 22, which are disposed on the outermost side in the left-right direction. Hence, even if the main pipes 22 are broken by the external force applied to the main pipes 22, it is possible to prevent the refrigerant from entering the battery trays 12 disposed inside the battery frame 11. Accordingly, in the power storage device 3, 103, the risk of the secondary battery cells 14 coming into contact with the refrigerant and leaking is reduced.

In addition, in the power storage device 3, 103, because the cooling plate 13, 113 also serves as the upper lid, the component count is reduced, and thus, the weight and cost are reduced, compared with a case where the upper lid is separately provided.

Furthermore, because the plate portion 21, 121 is in contact with the bus bars 15 with the insulating members 17 therebetween, it is possible to efficiently cool the bus bars 15, which generate a large amount of heat, and thus to improve the cooling efficiency.

The battery frame 11 and the cooling plates 13, 113 are fixed to the vehicle 1, and the battery trays 12 can be attached to the battery frame 11 from below.

Hence, for example, when the secondary battery cells 14 fail, the battery trays 12 alone can be removed from the vehicle 1, without removing the cooling pipes. Accordingly, the maintainability of the power storage device 3, 103 is improved.

In the plate portion 21, the refrigerant flow paths 21c, through which the refrigerant flows, are formed by joining the two plates 21a and 21b together.

Hence, in the plate portion 21, the refrigerant flow paths 21c can be easily formed in a desired shape.

The plate portion 121 is formed by extrusion molding such that the refrigerant flow paths 121a, through which the refrigerant flows, are formed.

Thus, in the plate portion 121, the refrigerant flow paths 121a extending in the left-right direction can be easily formed. Furthermore, the rigidity of the plate portion 121 against an external force applied in the left-right direction is increased. Accordingly, in the power storage device 103, the risk of the secondary battery cells 14 coming into contact with the refrigerant and leaking is further reduced.

The battery trays 12 include the spring members 16 that press the secondary battery cells 14 upward.

With this configuration, the secondary battery cells 14 can be pressed against the cooling plate 13, 113 and more stably brought into close contact with the cooling plate 13, 113. Accordingly, the cooling performance of the power storage device 3, 103 is improved.

1. A power storage device to be mounted below a floor of a vehicle, the power storage device comprising:
a battery tray accommodating a secondary battery cell;
a battery frame surrounding the battery tray; and
a cooling plate comprising a plate portion provided above the battery tray and the battery frame and having a refrigerant flow path through which a refrigerant is to flow, and a main pipe disposed on an outer side of the battery frame so as to overlap the battery frame in a top-bottom direction and continuous with the plate portion such that the refrigerant flow path and an internal space of the main pipe communicate with each other.

2. The power storage device according to claim 1, wherein the battery frame and the cooling plate are fixed to the vehicle, and the battery tray is attachable to the battery frame from below.

3. The power storage device according to claim 1, wherein the refrigerant flow path in the plate portion is formed by joining two plates.

4. The power storage device according to claim 2, wherein the refrigerant flow path in the plate portion is formed by joining two plates.

5. The power storage device according to claim 1, wherein the plate portion is formed by extrusion molding such that the refrigerant flow path is formed.

6. The power storage device according to claim 2, wherein the plate portion is formed by extrusion molding such that the refrigerant flow path is formed.

7. The power storage device according to claim 1, wherein the battery tray comprises a spring member that presses the secondary battery cell upward.

8. The power storage device according to claim 2, wherein the battery tray comprises a spring member that presses the secondary battery cell upward.
